(19) United States
(12) Patent Application Publication
(10) Pub. No.: US 2015/0132736 A1
(43) Pub. Date: May 14, 2015

(54) TEACHING AID

(71) Applicant: JOAN GILMORE, SHREWSBURY, MA (US)

(72) Inventor: JOAN GILMORE, SHREWSBURY, MA (US)

(21) Appl. No.: 14/479,351

(22) Filed: Sep. 7, 2014

Related U.S. Application Data
(60) Provisional application No. 61/875,094, filed on Sep. 8, 2013.

(51) Int. Cl. B42D 3/12; B42D 3/16; B42D 3/18; G09F 7/18

(52) U.S. Cl. CPC B42D 3/126; G09F 7/18; B42D 3/16; B42D 3/18
USPC 434/365

(57) ABSTRACT

A aid for reading a picture book aloud to a group of students, while showing the pictures to the students. A teaching aid showing information about the content of the pages in a book, is mounted on the open covers on the book, facing away from the pages, so that the teacher can show the contents of the pages of a book to the students, and, while being positioned behind the book, and can still know what is being shown.

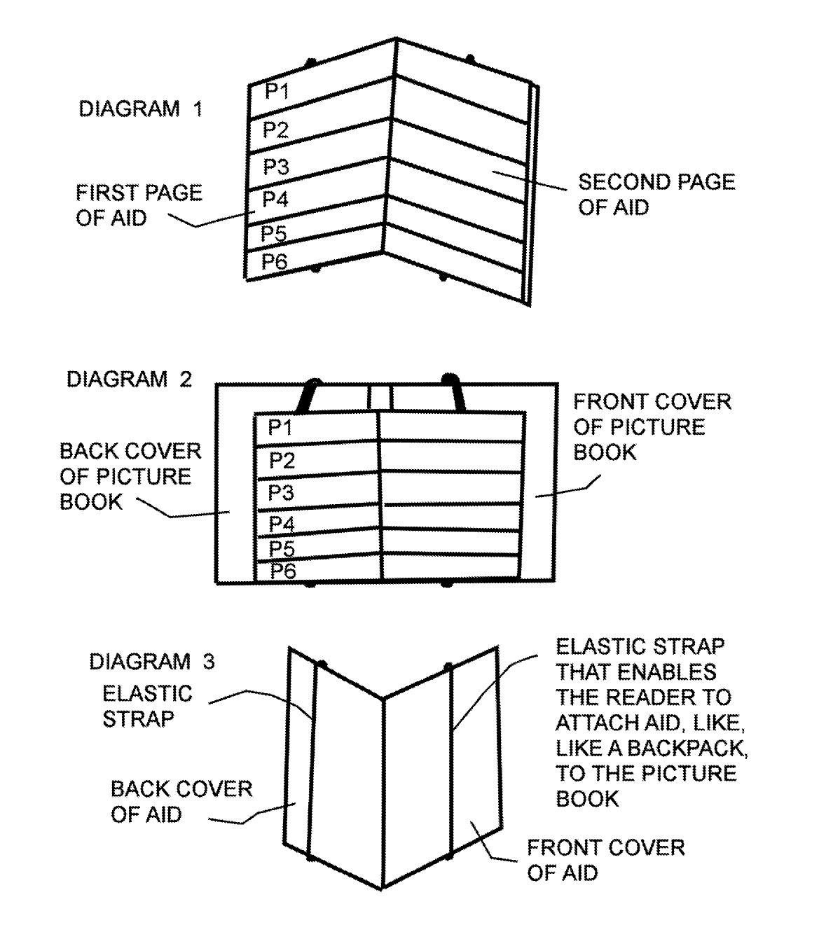

### PURPOSE

This is an aid to reading a picture books aloud to a group of students, while showing the pictures to the students.

### DESCRIPTION

This aid is a smaller adapted version of the picture book. The aid is enclosed in a plastic pocket folder that adheres to the inside back cover of the picture book with elastic straps attached on the front and back cover of the aid which will be placed like a backpack to the picture book. The aid will have the text (and perhaps a small image) of each of several pages of the picture book printed on each page of the aid. See diagram 1. How the aid attaches to the picture book—see diagram 2. How the aid adheres to the back cover of the picture book—see diagram 3.

### PROBLEMS WITH READING PICTURE BOOKS

1. The reader will have to crane his/her neck to read the words while still trying to hold the book so the students can see the pictures.
2. Neck strain with longer picture books.
3. The reader often has difficulty read words sideways.
4. The reader's voice is not directed at the students when reading the picture book.
5. The reader blocks some of the students' view of the pictures with your head while reading.
6. Some students who can't see or really hear the book can lose interest and act up.

### ADVANTAGES OF THIS AID

1. This aid allows the teacher or volunteer reader to hold the picture book so all students can see it.
2. This aid allows the teacher or volunteer reader to face the students while reading the words.
3. The children will be more engaged in the book since they can see it and hear it better.
4. This aid allows the teachers and volunteer readers to be able to keep their eyes on the students with greater ease.
5. Teachers or volunteer readers can manage students more easily and efficiently.
7. Students have maximum viewing of the pictures.
8. The reader's voice is directed at the students.
9. The students can see the teacher's or volunteer readers' facial expressions.
10. Ease of use.
11. This aid can be purchased individually or included with the picture book.
12. Old books can be retrofitted.
13. Reading to a group of students will be easier and more enjoyable.
14. Won't strain neck muscles.
15. Generates new income for a book company.

### BRIEF DESCRIPTION OF THE DRAWINGS

Diagram 1 is a drawing of a teaching aid embodying the principles of the present invention.

Diagram 2 is drawing of the teaching aid, shown in Diagram 1, mounted on the covers of a picture book, and forming a combination embodying the principles of the present invention.

Diagram 3 is drawing of the teaching aid, shown in Diagram 1, showing the means by which the aid is mounted on the covers of a picture book, to form a combination embodying the principles of the present invention.

1. A teaching aid system for presenting a book to a group of students, comprising:
a.) a book containing material, on its front side, to be shown to students, and having a back side,
b.) a teaching aid containing information about the material on its back side, and having a front side, and
c.) a mounting system that mounts the front side of the aid to the back side of the book.

2. A teaching aid for being mounted on a book containing material to be presented to a group of students, the book having a front side, to be shown to students, and having a back side, comprising:
a.) a teaching aid containing information about the material on its back side, and having a front side, and
b.) a mounting system that mounts the front side of the aid to the back side of the book.

3. A method for presenting a book to a group of students, the book containing material, on its front side, to be shown to students, and having a back side, and a teaching aid containing information about the material on its back side, and having a front side, comprising the steps of:
a.) mounting the front side of the aid to the back side of the book, and
b.) presenting the material to the students, while viewing the information.
